(19) United States
(12) Patent Application Publication
(10) Pub. No.: US 2025/0384662 A1
(43) Pub. Date: Dec. 18, 2025

(54) MODEL GENERATION METHOD, IMAGE CLASSIFICATION METHOD, CONTROLLER AND ELECTRONIC DEVICE

(71) Applicant: THIRD REALITY, INC., Zhenjiang, Jiangsu (CN)

(72) Inventors: Xuezhang DONG, Zhenjiang, Jiangsu (CN); Chunsheng YU, Zhenjiang, Jiangsu (CN)

(21) Appl. No.: 18/992,442

(22) PCT Filed: Jul. 26, 2022
(86) PCT No.: PCT/CN2022/107857

§ 371 Date: Jan. 8, 2025

(51) Int. Cl. G06V 10/764; G06V 10/774; G06V 10/82

(52) U.S. Cl. CPC G06V 10/764; G06V 10/7753; G06V 10/82

(57) ABSTRACT

Embodiments of the present invention provide a model generation method, an image classification method, a controller, and an electronic device. The model generation method comprises: constructing a convolutional neural network model for image classification, and dividing the convolutional neural network model into N modules in sequence, wherein each module comprises multiple adjacent layers in the neural network model, and N is an integer greater than 1; based on unlabeled training data, training first to (N-1)-th module to obtain parameters and models of the first module to the (N-1)-th module; and cascading the trained first to (N-1)-th modules with N-th module, and training the cascaded N modules by using labeled training data, to obtain the parameters and models of the modules. A high-precision convolutional neural network model can be obtained without the need to label a large amount of training data, and the labor and time required for labeling the training data are saved.

### TECHNICAL FIELD

The present invention relates to the field of image processing technology, and specifically relates to a model generation method, an image classification method, a controller and an electronic device.

### BACKGROUND

With the advancement of computer hardware technology, deep learning models can run on the latest 32-bit microcontrollers. The power consumption of existing commonly used microcontrollers (MCUs) is only a few milliwatts. Based on the low power consumption features of microcontrollers, devices using microcontrollers can be powered by button batteries or some solar cells. Microcontrollers are an important part of the development of the Internet of Things. The real-time operating system (RTOS) has been widely used on the STM32 platform of STMicroelectronics, the ESP32 platform of Espressif Systems, and Arduino platform; the real-time operating system enables the microcontroller to support multi-processors (CPU), multi-threaded applications.

Image classification is an image processing method that distinguishes different categories of targets based on the different features reflected by the targets of different categories in the image information; that is, for a given image, determine what categories of targets are contained in the image. The convolutional neural network (CNN) for image classification based on deep learning is a feed-forward neural network where its artificial neurons can respond to surrounding units within a part of the coverage area and have excellent performance in large-scale image processing. The convolutional neural network model architecture is a multi-layer structure, in which after the first input layer, the image has several convolutional layers, batch normalization layers, and downsampling layers arranged in various orders, finally, the output layer outputs the category of the image.

The more convolutional layers of the convolutional neural network model, the higher its representation ability. However, the more layers of the convolutional neural network model, the more parameters involved. For example, the image classification model MobilenetV2 that can be used in mobile phones has about 3.5M parameters, but the current microcontroller has only about 256 KB to 512 KB on-chip memory, MobilenetV2 cannot be used in the microcontroller, so only image classification convolutional neural networks with fewer layers can be run on the microcontroller.

### SUMMARY

An object of the present invention is to provide a model generation method, image classification method, controller and electronic equipment, which can obtain a high-precision convolutional neural network model without the need to label a large amount of training data, while saving the labor and time required for labeling the training data.

In order to achieve the above object, the present invention provides a model generation method, comprising: constructing a convolutional neural network model for image classification, and dividing the convolutional neural network model into N modules in sequence, each of the modules includes multiple adjacent layers in the neural network model, and N is an integer greater than 1; based on unlabeled training data, training a first module to an (N-1)-th module to obtain parameters and models of the first to (N-1)-th modules; cascading the trained first to (N-1)-th modules with a N-th module, and using labeled training data to train the cascaded N modules to obtain the parameters and models of the modules.

The present invention also provides an image classification method, comprising: obtaining a convolutional neural network model used to classify images to be classified, wherein the convolutional neural network model is generated based on the above-mentioned model generation method; using the obtained convolution neural network model to classify the images to be classified.

The present invention also provides a controller for executing the above-mentioned model generation method and/or the above-mentioned image classification method.

The invention also provides an electronic device, comprising: the above-mentioned controller and a memory communicatively connected with the controller.

This embodiment provides a model generation method, firstly constructing a convolutional neural network model for image classification, and dividing the multi-layer structure of the constructed convolutional neural network model into N modules in sequence, each module including multiple adjacent layers in the neural network model; and then training the first to (N-1)-th modules based on unlabeled training data to obtain parameters and models of the first to (N-1)-th modules, that is, using unlabeled training data to pre-train the first N-1 modules, thus enabling the first N-1 modules to learn the features of the unlabeled training data in advance, and then cascading the trained first N-1 modules with a N-th module, and using the labeled training data to train the cascaded N modules to obtain parameters and models of the modules, since the first N-1 modules have learned the features of the unlabeled training data in advance, at this time, the cascaded convolutional neural network model may be supervisedly learned and trained using only a small amount of labeled training data, and obtaining the final convolutional neural network model, a high-precision convolutional neural network model can be obtained without the need to label a large amount of training data, and the labor and time required for labeling the training data are saved.

In one embodiment, training the first to (N-1)-th modules based on unlabeled training data to obtain parameters and models of each target module, including: for each target module, using the target module as an encoding module of an autoencoder to design a decoding module of the autoencoder, and training the autoencoder based on unlabeled training data to obtain the parameters and models of the target module, wherein the target module is one of the first to (N-1)-th modules.

In one embodiment, for each target module, using the target module as an encoding module of an autoencoder to design a decoding module of the autoencoder, and training the autoencoder based on unlabeled training data to obtain the parameters and models of the target module, including: for the first module, using unlabeled training data to train the first module to obtain the parameters and models of the first module; for the M-th module, using output data of the (M-1)-th module to train the M-th module to obtain the parameters and models of the M-th module; wherein 1<M≤N-1, and M is an integer.

In one embodiment, for each of the modules, the memory occupied by the parameters of the module corresponding to the multi-layer structure model is less than the on-chip storage of the controller running the convolutional neural network model.

In one embodiment, after cascading the trained first N-1 modules with a N-th module, and using the labeled training data to train the cascaded N modules to obtain parameters and models of the modules, the method further includes: converting the parameters and models of the modules into a format for running on the controller respectively.

In one embodiment, constructing a convolutional neural network model for image classification includes: generating a convolution neural network model for classifying the image to be classified based on the attributes of the image to be classified and the system parameters of the controller.

In one embodiment, in the obtained convolutional neural network model, the memory occupied by the parameters of each of the modules corresponding to the multi-layer structure model is less than the on-chip storage of the controller; using the obtained convolutional neural network model to classify the image to be classified, includes: running multiple modules included in the obtained convolutional neural network model in parallel in multiple threads or processors of the controller, to classify the images to be classified.

### BRIEF DESCRIPTION OF THE DRAWINGS

FIG. 1 is a specific flow chart of a model generation method according to the first embodiment of the present invention;

FIG. 2 is a schematic diagram of a convolutional neural network model according to the first embodiment of the present invention;

FIG. 3 is a flow chart of step 102 of the model generation method in FIG. 1;

FIG. 4 is a specific flow chart of an image classification method according to the second embodiment of the present invention.

### DETAILED DESCRIPTION OF PREFERRED EMBODIMENTS

Each embodiment of the present application will be described in detail hereinafter in conjunction with the accompanying drawings for a clearer understanding of the purposes, features and advantages of the present application. It should be understood that the embodiments shown in the accompanying drawings are not intended to be a limitation of the scope of the present application, but are merely intended to illustrate the substantive spirit of the technical solution of the present application.

In the following description, certain specific details are set forth for the purpose of illustrating various disclosed embodiments to provide a thorough understanding of various disclosed embodiments. However, those skilled in the related art will recognize that embodiments may be practiced without one or more of these specific details. In other cases, familiar devices, structures, and techniques associated with the present application may not be shown or described in detail so as to avoid unnecessarily confusing the description of the embodiments.

Unless the context requires otherwise, throughout the specification and the claims, the words “including” and variants thereof, such as “comprising” and “having”, are to be understood as open-ended and inclusive meaning, i.e., should be interpreted as “including, but not limited to”.

References to “one embodiment” or “an embodiment” throughout the specification indicate that a particular feature, structure, or feature described in conjunction with an embodiment is included in at least one embodiment. Therefore, the occurrence of “in one embodiment” or “in an embodiment” at various locations throughout the specification need not all refer to the same embodiment. In addition, particular features, structures or features may be combined in any manner in one or more embodiments.

As used in the specification and in the appended claims, the singular forms “a” and “an” include plural referents, unless the context clearly provides otherwise. It should be noted that the term “or” is normally used in its inclusive sense of “or/and”, unless the context clearly provides otherwise.

In the following description, in order to clearly show the structure and working method of this application, it will be described with the help of many directional words, but words such as “front”, “back”, “left”, “right”, “outside”, “inside”, “outward”, “inward”, “up”, “down”, and the like should be understood as convenient terms and not as limiting terms.

The first embodiment of the present invention relates to a model generation method for training a convolutional neural network model, and the trained convolutional neural network can be used for image classification.

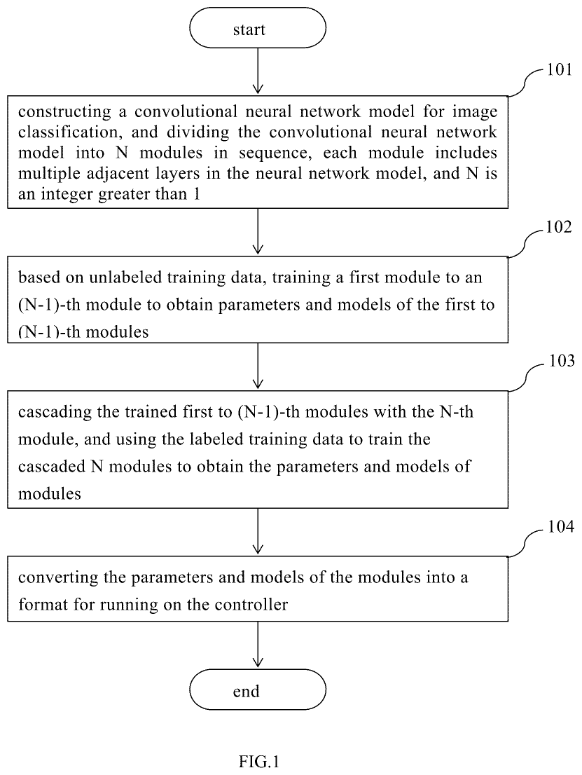

The specific process of the model generation method in this embodiment is shown in FIG. 1.

Step 101: constructing a convolutional neural network model for image classification, and dividing the convolutional neural network model into N modules in sequence, each module includes multiple adjacent layers in the neural network model, and N is an integer greater than 1.

Specifically, the convolutional neural network model is used for image classification, which may be constructed based on the attributes of the image to be classified and the parameters of the controller running the convolutional neural network model, after constructing the convolutional neural network model with a multi-layer structure, the multi-layer structure of the convolutional neural network model is divided into N modules (N is an integer greater than 1) in sequence, each module includes multiple layers of the convolutional neural network model, a complete convolutional neural network model may be obtained after multiple modules are connected in sequence. Wherein the controller can be an MCU microcontroller.

In one example, for each module, the memory occupied by the parameters of the module corresponding to the multi-layer structure model is less than the on-chip storage of the controller running the convolutional neural network model. That is, when dividing the convolutional neural network model, it is necessary to ensure that the memory occupied by the parameters of each module obtained by dividing that corresponds to the multi-layer structure model is less than the on-chip storage of the controller to ensure that a single module can run on the controller; moreover, later multiple modules may also be selected to run in parallel in multiple threads in the controller, or for a controller including multiple processors, multiple modules can run in parallel in multiple processors, thereby enable the faster operational speed of the controller, and improving the speed of classifying the images to be classified.

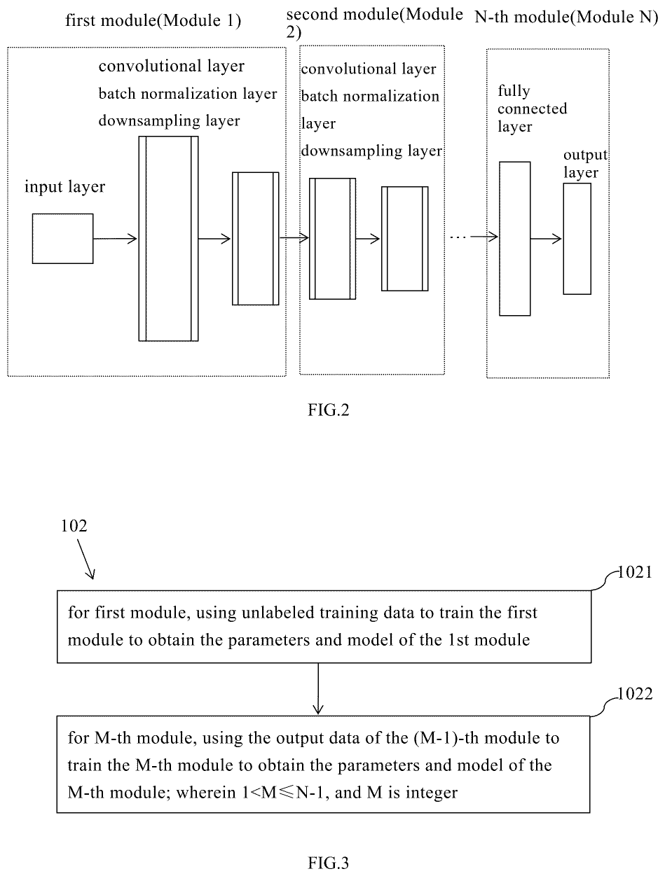

Taking the convolutional neural network model in FIG. 2 as an example, a first layer of the convolutional neural network model is the input layer, which is used to receive input images, after the input layer, there are several convolutional layers, batch normalization layer and downsampling layer arranged in sequence, which are used for feature extraction, the extracted features are connected to the final output layer through a fully connected layer, and the output layer outputs the category of the content in the image.

When dividing the convolutional neural network model in FIG. 2, the output layer is cascaded with several groups (two groups are taken as an example in FIG. 2) of convolutional layers, batch normalization layers and downsampling layers to form module 1, and several subsequent groups of (two groups are taken as an example in FIG. 2) convolutional layer, batch normalization layer and downsampling layer are concatenated to form module 2, repeating the above process, module 3 to module N-1 can be obtained by dividing in sequence, and finally the fully connected layer and the output layer are divided into module N.

Step 102: based on unlabeled training data, training a first module to an (N-1)-th module to obtain parameters and models of the first to (N-1)-th modules.

Specifically, after completing the division of the convolutional neural network model in step 101, training the first to (N-1)-th modules in sequence to obtain and save the parameters and models of each module in the first to (N-1)-th modules, wherein the parameters of each module include the connection weights between each layer in the module.

In one example, training the first module to the (N-1)-th module based on unlabeled training data to obtain the parameters and models of each target module, including: for each target module, using the target module as an encoding module of an autoencoder to design a decoding module of the autoencoder, and training the autoencoder based on unlabeled training data to obtain the parameters and models of the target module, wherein the target module is one of the first module to the (N-1)-th module.

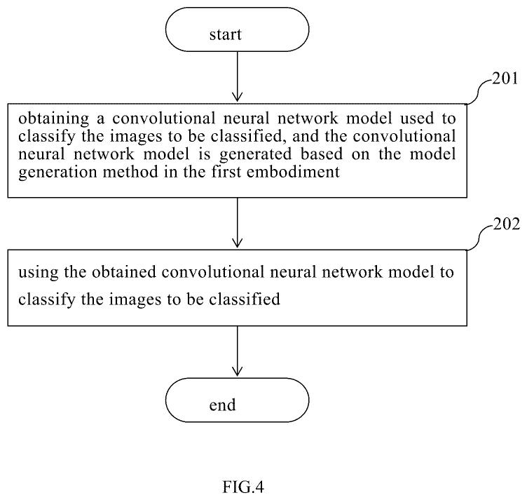

Referring to FIG. 3, in step 102, for each target module, using the target module as the encoding module of the autoencoder to design the decoding module of the autoencoder, and training the autoencoder based on unlabeled training data to obtain the parameters and models of the target module, including the following sub-steps:

Sub-step 1021, for first module, using unlabeled training data to train the first module to obtain the parameters and model of the first module.

Sub-step 1022, for M-th module, using the output data of the (M-1)-th module to train the M-th module to obtain the parameters and model of the M-th module; wherein 1<M≤N-1, and M is integer.

Taking the convolutional neural network model in FIG. 2 as an example, during the training process of the convolutional neural network model, training the first module (Module 1) to the (N-1)-th module (Module N-1) in sequence, taking Module 1 as an example, firstly using module 1 as the encoding module 11 of the autoencoder to design the decoding module 12 of the autoencoder, thus the encoding module 11 (Module 1) and the decoding module 12 form an autoencoder, since the autoencoder belongs to unsupervised learning and does not rely on the labeling of training data, it can automatically find the relationship between the training data by mining the inherent features of the training data, so that the autoencoder can be trained using the unlabeled training data; inputting the unlabeled training data to the encoding module 11 (Module 1), mapping the training data to the feature space through the encoding module 11 (module 1), and then using the decoding module 12 to map the sampling features obtained from the encoding module 11 (Module 1) back to the original space to obtain reconstructed data, and then comparing the reconstructed data with the training data to obtain the reconstruction error, using minimizing reconstruction error as the optimization goal to optimize the encoding module 11 (Module 1) and the decoding module 12 to obtain the final required encoding module 11 (Module 1), saving the parameters and models of the encoding module 11 (Module 1), and the encoding module 11 (Module 1) learns to obtain an abstract feature representation for the training data input.

For the 2nd module (Module 2) to the (N-1)-th module (Module N-1), the training method adopted is similar to the training method of Module 1, the main difference is that the input of each module is the output of the previous module, for example, when training Module 2, the input data used is the output data of Module 1. The specific training process of the 2nd module (Module 2) to the (N-1)-th module (Module N-1) will not be repeatedly described herein, after training, the parameters and models of Module 2 to Module N-1 can be obtained and saved.

Based on the above process, the unlabeled training data can be used to perform unsupervised learning training on Module 1 to Module N-1, so that the convolutional neural network model learns the features of the training data.

Step 103, cascading the trained first to (N-1)-th modules with the N-th module, and using the labeled training data to train the cascaded N modules to obtain the parameters and models of each module.

Specifically, after the above-mentioned pre-training of Module 1 to Module N-1, cascading Module 1 to Module N in sequence, that is, according to the division order after division, combining Module 1 to Module N-1 to obtain a complete convolutional neural network model, and then using the labeled training data to perform supervised learning training on the combined convolutional neural network model, and since Module 1 to Module N have learned the features of the training data in step 102, in this step, only a small amount of labeled training data is needed to perform supervised learning training on the convolutional neural network model, after training the combined convolutional neural network model is completed, obtaining the final convolutional neural network model, and saving the parameters and models of Module 1 to Module N respectively.

In one example, after step 103, the method also includes:

Step 104: converting the parameters and models of each module into a format for running on the controller.

Specifically, after saving the final parameters and models of Module 1 to Module N in step 103, converting the parameters and models of Module 1 to Module N respectively, so that Module 1 to Module N can run on the controller. For example, the parameters and models of multiple modules are converted into code forms, so that multiple modules can be compiled directly in the controller, which reduces the memory usage of the modules in the controller and improves the running speed.

This embodiment provides a model generation method, firstly constructing a convolutional neural network model for image classification, and dividing the multi-layer structure of the constructed convolutional neural network model into N modules in sequence, each module including multiple adjacent layers in the neural network model; and then training the first to (N-1)-th modules based on unlabeled training data to obtain parameters and models of the first to (N-1)-th modules, that is, using unlabeled training data to pre-train the first N-1 modules, thus enabling the first N-1 modules to learn the features of the unlabeled training data in advance, and then cascading the trained first N-1 modules with a N-th module, and using the labeled training data to train the cascaded N modules to obtain parameters and models of the modules, since the first N-1 modules have learned the features of the unlabeled training data in advance, at this time, the cascaded convolutional neural network model may be supervisedly learned and trained using only a small amount of labeled training data, and obtaining the final convolutional neural network model, a high-precision convolutional neural network model can be obtained without the need to label a large amount of training data, and the labor and time required for labeling the training data are saved.

The second embodiment of the present invention discloses an image classification method, which is applied to a controller (which can be an MCU microcontroller), a convolutional neural network model used for image classification runs in the controller, so that the input images to be classified can be classified.

The specific process of the image classification method in this embodiment is shown in FIG. 4.

Step 201: obtaining a convolutional neural network model used to classify the images to be classified, and the convolutional neural network model is generated based on the model generation method in the first embodiment.

Specifically, the convolutional neural network model used for image classification is generated based on the model generation method in the first embodiment, the convolutional neural network model can be run in the controller after generated.

Step 202: using the obtained convolutional neural network model to classify the images to be classified.

In one example, in the obtained convolutional neural network model, the memory occupied by the parameters of each module corresponding to the multi-layer structure model is less than the on-chip storage of the running controller; using the obtained convolutional neural network model to classify the images to be classified, includes: running multiple modules contained in the obtained convolutional neural network model in parallel in multiple threads or processors of the controller, and classifying the images to be classified. That is, in the convolutional neural network model generated in the first embodiment, the memory required for each module to run the convolutional neural network model is less than the on-chip storage of the controller, so that each module can be run in the controller, multiple modules can then be selected to run in parallel in multiple threads in the controller, or for controllers including multiple processors, multiple modules can be run in parallel in the multiple processors, thereby accelerating the computing speed of the controller, and improving the speed of classifying the images to be classified and being suitable for low-power microprocessors. For example, multiple modules run in different processors respectively, for the processor running the first module, after acquiring the current image to be classified and completing the processing, it sends the obtained data to the processor running the second module, and the data will be further processed by the processor running the second module, and so on, the processor running the first module will collect and process the next image after sending the current data to the processor running the second module.

The third embodiment of the present invention discloses a controller, such as an MCU controller, which is used to execute the model generation method in the first embodiment and/or the image classification method in the second embodiment, that is, the controller can run the model generation method and the image classification method at the same time, or the model generation method and the image classification method are implemented by different controllers respectively. For example, a model training process required higher computing power involved in the model generation method can be handed by the controller with higher processing power, then the controller sends the generated convolutional neural network model to a low-power microcontroller, and the low-power microcontroller performs image classification based on the convolutional neural network.

The fourth embodiment of the present invention discloses an electronic device. The electronic device includes the controller in the third embodiment and a memory communicatively connected to the controller.

Preferred embodiments of the present invention have been described in detail above, but it should be understood that aspects of the embodiments can be modified to employ aspects, features and ideas from various patents, applications and publications to provide additional embodiments, if desired.

These and other variations to the embodiments can be made in view of the detailed description above. Generally, in the claims, the terms used should not be considered as limiting the specific embodiments disclosed in the specification and claims, but should be understood to include all possible embodiments together with the full scope of equivalents enjoyed by those claims.

1. A model generation method, wherein the method comprising:
constructing a convolutional neural network model for image classification, and dividing the convolutional neural network model into N modules in sequence, each of the modules includes multiple adjacent layers in the neural network model, and Nis an integer greater than 1;
based on unlabeled training data, training a first module to an (N-1)-th module to obtain parameters and models of the first to (N-1)-th modules;
cascading the trained first to (N-1)-th modules with an N-th module, and using labeled training data to train the cascaded N modules to obtain the parameters and models of the modules.

2. A model generation method according to claim 1, wherein based on unlabeled training data, training a first to an (N-1)-th modules to obtain parameters and models of each target module, including:
for each target module, using the target module as an encoding module of an autoencoder to design an decoding module of the autoencoder, and training the autoencoder based on the unlabeled training data to obtain the parameters and models of the target module, wherein the target module is one of the first to (N-1)-th modules.

3. A model generation method according to claim 2, wherein for each target module, using the target module as an encoding module of an autoencoder to design a decoding module of the autoencoder, and training the autoencoder based on unlabeled training data to obtain the parameters and models of the target module, including:
for the first module, using unlabeled training data to train the first module to obtain the parameters and models of the first module; for the M-th module, using output data of the (M-1)-th module to train the M-th module to obtain the parameters and models of the M-th module; wherein 1<M≤N-1, and M is an integer.

4. A model generation method according to claim 1, wherein for each of the modules, the memory occupied by the parameters of the module corresponding to the multi-layer structure model is less than the on-chip storage of the controller running the convolutional neural network model.

5. A model generation method according to claim 1, wherein after cascading the trained first to (N-1)-th modules with an N-th module, and using the labeled training data to train the cascaded N modules, to obtain the parameters and models of the modules, the method further comprises:
converting the parameters and models of the modules into a format for running on the controller.

6. A model generation method according to claim 1, wherein the constructing a convolutional neural network model for image classification includes:
based on the attributes of the image to be classified and the system parameters of the controller, generating a convolutional neural network model for classifying the images to be classified.

7. An image classification method, wherein it is applied to a controller, the method includes:
obtaining a convolutional neural network model for classifying the images to be classified, the convolutional neural network model is generated based on the model generation method according to claim 1;
using the obtained convolutional neural network model to classify the images to be classified.

8. An image classification method according to claim 7, wherein in the obtained convolutional neural network model, the memory occupied by the parameters of each module corresponding to the multi-layer structure model is less than the on-chip storage of the controller; the using the obtained convolutional neural network model to classify the images to be classified, including:
running multiple modules included in the obtained convolutional neural network model in parallel in multiple threads or processors of the controller to classify the images to be classified.

9. A controller, wherein it is used for executing a model generation method according to claim 1.

10. An electronic device, wherein it includes: a controller according to claim 9 and a memory communicatively connected with the controller.
